(19) United States
(12) Patent Application Publication
(10) Pub. No.: US 2012/0007881 A1
(43) Pub. Date: Jan. 12, 2012

(54) Method for the presentation of biometric data of a signature

(75) Inventors: Paolo Forlani, Milano (IT); Antonio Carbonera, Pavia (IT); Roberto Garavaglia, Bernate Ticino (IT)

(73) Assignee: PRB SRL, Milano (IT)

(21) Appl. No.: 13/018,440

(22) Filed: Feb. 1, 2011

(30) Foreign Application Priority Data
Jul. 7, 2010 (IT) MI2010A001245

(51) Int. Cl. G09G 5/00

(52) U.S. Cl. 345/619

(57) ABSTRACT

In the field of electronics specialized tablets are used to capture signatures, capable of registering, in addition to the shape of the signature, its “biometric data”: the instantaneous speed of the stylus and the instantaneous pressure exerted on the tip.

A human can perfectly see and recognize in minimum details the shape of the signature, but cannot evaluate at the same time also instantaneous speed and pressure data; the method, subject of the present invention, solves the problem due to the presentation at the same time of the shape of the signature, of instantaneous pressure and of instantaneous speed, being based on the creation of a three-dimensional graphical representation of the signature with an immediate optical effect, where the signature appears as a three-dimensional solid. Even for an operator without experience in the graphological field it is easy to achieve a quite reliable judgment about the validity of a signature, by comparing its three-dimensional image with that of a reference signature, also three-dimensional.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

In the field of electronics for many years graphic tablets have been in use, that allow to capture the drawing or the handwriting made with a stylus on the surface of the tablet, transforming it in digital format.

Also specialized tablets exist for the capture of a signature, that have the capability to record, in addition to the shape of the signature, the instantaneous speed of the stylus and the instantaneous pressure exerted on the tip, also called “biometric data” of the signature.

These biometric data are very difficult to imitate, therefore they are used by expert graphologists to formulate reliable analysis on the validity of digitized signatures.

As an example of present art it is possible to see the patent U.S. Pat. No. 6,307,955 (B1) “Electronic signature management system”.

The technique described above achieves its purpose to give probationary validity to digital signatures, but a problem remains due to the difficulty to read recorded biometric data. As a matter of fact, a human can perfectly see and recognize up to minute details the shape of the signature, but cannot evaluate at the same time also instantaneous speed and pressure data, that are recorded electronically as sequences of numbers. Appropriate visualization techniques have been developed to allow the evaluation of these biometric data during a graphological analysis.

According to one of these techniques, the signature is graphically displayed with a thinner or thicker stroke: where the speed of the pen is lower a thicker stroke is used, and where the speed is higher a thinner stroke is used.

Pressure is displayed similarly, using a thicker stroke where pressure is higher and a thinner stroke where the pressure is lower.

The variable thickness of the stroke mimics the distribution of ink for a signature written on paper: indeed the lower speed of the pen or the higher pressure allow a bigger ink deposition, and vice versa the higher speed of the pen or the lower pressure reduce the ink deposition.

Another technique consists in the reproduction of a speed and pressure diagram in a cartesian coordinate system as a function of time, starting from the moment when signature tracing starts and ending when tracing stops.

The techniques described above enable the graphologist, during the often laborious investigation concerning an analysis, to display and check biometric data of a signature, but do not allow an immediate and easily understandable presentation in a few moments, as is needed by a bank clerk to evaluate, in the presence of the customer, if the signature deposited on the tablet conforms to a previously stored specimen.

### BRIEF SUMMARY OF THE INVENTION

The method according to the present invention solves the problem due to the concurrent presentation of the shape of the signature, of instantaneous pressure and of instantaneous speed and allows a quick evaluation of the conformity of the signature with a reference signature, without the need for a laborious graphological verification; on the other side, also for the expert graphologist it is a useful help during detailed verification.

### BRIEF DESCRIPTION OF THE SEVERAL VIEWS OF THE DRAWING

The following description refers to the enclosed FIGS. 1 and 2.

FIG. 1 is the representation of a section of a displayed signature;

FIG. 2 is the representation of a single letter.

### DETAILED DESCRIPTION OF THE INVENTION

The method consists in creating a graphical three-dimensional representation of the signature where:

The shape of the signature is reproduced in two dimensions (X and Y), exactly as it is drawn on the plate of the tablet, or as if it were on the surface of the paper for a traditional signature

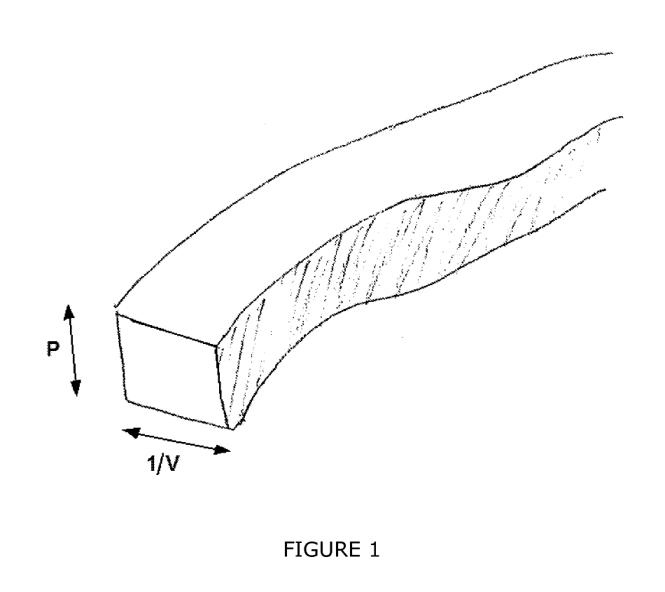

Instantaneous speed is painted using a variable thickness stroke, as in the technique previously described: larger thickness where speed is lower and vice versa. See FIG. 1, where thickness is schematically referenced as 1/V.

Instantaneous pressure is painted using the third dimension of the graphical space (Z): where pressure is bigger, the depth with which the stroke is represented is taller. See FIG. 1, where depth is schematically represented as P.

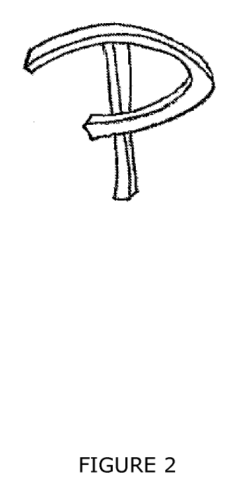

The result, an example of which can be seen in FIG. 2, is a representation with an immediate optical effect, where the signature appears as a three-dimensional solid. By using normal and well-known three-dimensional graphical transformation techniques, the image can be rotated in various axes or zoomed to display the hidden or minute parts.

Even for an operator without experience in the graphological field it is easy to reach a quite reliable judgment about the validity of a signature, comparing its three-dimensional image with that of a reference signature, also three-dimensional.

In order to better clarify the method subject of the present invention, in the following text the description of a possible embodiment is given.

The signature device, as with preexisting technology, is a graphic tablet made with a liquid crystal display with a transparent digitizer superimposed. The digitizer can capture, in addition to the shape of the signature in the X,Y coordinates of the tablet plate, also the instantaneous speed of the stylus and the instantaneous pressure exerted on the stylus by the hand of the writer (biometric data); also these features are part of the art before the present invention.

The method, subject of the invention, is used instead, after the completion of the acquisition of the signature, to represent, on the same display of the tablet or optionally in a second display or computer, the three-dimensional image obtained by combining shape, speed and pressure.

Several commands, accessible by means of buttons, allow to rotate and zoom the image; also by means of appropriate commands it is possible to show in the same display or in a second display or computer the image of a reference signature to make a comparison.

By the description and the drawing it is understood that the technique subject of the invention fully achieves its purpose; it is anyway necessary to note that numerous additions and modifications can be made to it without departing from its spirit and from its protection field, as it results by the following claims.

1. Method to graphically display a digitized signature, characterized by the fact that it shows simultaneously the shape of the signature, the instantaneous speed of the stylus and the instantaneous pressure applied on the stylus.

2. Method according to claim 1, characterized by the fact that it shows the shape of the signature in two dimensions (X and Y), exactly as on the plane of the tablet or as it were on the plane of the paper for a traditional signature.

3. Method according to preceding claims, characterized by the fact that it paints instant speed with a variable width stroke: bigger width where speed is lower and vice versa.

4. Method according to preceding claims, characterized by the fact that it paints instant pressure using the third dimension in the graphical space (Z or height): the bigger the pressure, the taller is the height used to display the stroke.

5. Method according to preceding claims, characterized by the fact that the digitized signature is displayed as a three-dimensional solid.

6. Method according to preceding claims, characterized by the fact that the image can be turned in different axes or zoomed to show hidden or minute parts.

7. Graphic tablet with the possibility to show in its own display, after the acquisition of the signature, the three-dimensional representation of the signature according to the method described in preceding claims.

8. Graphic tablet with the possibility to show the representation of the signature also or alternately in an additional display or computer.
